(19) United States
(12) Patent Application Publication
(10) Pub. No.: US 2015/0163590 A1
(43) Pub. Date: Jun. 11, 2015

(54) AUDIO OUTPUT DEVICE CAPABLE OF SWITCHING A SOUND FIELD

(71) Applicant: Wistron Corporation, New Taipei City (TW)

(72) Inventors: Chih-Ming Hsu, New Taipei City (TW); Kuo-Hua Chen, New Taipei City (TW)

(73) Assignee: Wistron Corporation, New Taipei City (TW)

(21) Appl. No.: 14/277,057

(22) Filed: May 14, 2014

(30) Foreign Application Priority Data
Dec. 10, 2013 (TW) 102223268

(51) Int. Cl. H04R 3/00

(52) U.S. Cl. CPC H04R 3/00; H04R 2201/021

(57) ABSTRACT

An audio output device includes a housing, a speaker, a switching unit, a fixing component and a control unit. An opening is formed on the housing. The speaker is for outputting sound. The switching unit is installed inside the housing. The fixing component is fixed in the opening of the housing for triggering the switching unit so that the switching unit outputs a switching signal. The control unit is electrically connected to the switching unit and the speaker, and the control unit controls the speaker to output sound in a corresponding sound field as the control unit receives the switching signal.

### BACKGROUND OF THE INVENTION

1. Field of the Invention

The present disclosure is to provide an audio output device, and more specifically, to an audio output device capable of switching a sound field when being installed in a wall-mounting mode.

2. Description of the Prior Art

A flat-screen television (TV) can be installed in a wall-mounting mode or a standing mode. Practically, there is much difference in outputting sound as the flat-screen television is installed in the wall-mounting mode or in the standing mode. In general, the flat-screen TV is often set in the standing mode as a default setting of the standard sound field mode, which is regarded as being installed in the standing mode, and a speaker of the flat-screen TV is facedown in the standing mode so that a supporting surface, such as a ground or a desk, can be a reflective surface for the sound. However, there is no reflective surface for the speaker as the flat-screen TV is installed in the wall-mounting mode, resulting in lack of quality of high frequency audio signals. It is necessary to adjust the sound field mode for the flat-screen TV installed in the wall-mounting mode to amplify the high frequency audio signals, such as manually switching the sound field mode by a user. Hence, it is an important issue to design a simple mechanism for correspondingly switching the sound field to amplify the high frequency audio signals as the flat-screen TV is installed in the wall-mounting mode, and for automatically restoring to the standard sound field mode as the flat-screen TV is installed in the standing mode.

### SUMMARY OF THE INVENTION

The present disclosure is to provide an audio output device capable of switching a sound field when installing in a wall-mounting mode, to solve the above drawbacks.

According to the disclosure, the audio output device includes a housing, a speaker, a switching unit, a fixing component and a control unit. An opening is formed on the housing. The speaker is for outputting sound. The switching unit is installed inside the housing. The fixing component is fixed in the opening of the housing for pressing to trigger the switching unit so that the switching unit outputs a switching signal. The control unit is electrically connected to the switching unit and the speaker, and the control unit controls the speaker to output sound in a corresponding sound field mode as the control unit receives the switching signal.

According to the disclosure, the control unit includes a general purpose input/output (GPIO) port electrically connected to the switching unit.

According to the disclosure, the switching unit is grounded to output a low level switching signal to the general purpose input/output port, as the fixing component is fixed in the opening and presses to trigger the switching unit.

According to the disclosure, the control unit amplifies amplitude of a high frequency audio signal output from the speaker so as to control the speaker to output the sound in a wall-mounting sound field mode, as the control unit receives the switching signal.

According to the disclosure, the control unit does not amplify the amplitude of the high frequency audio signal output from the speaker so as to control the speaker to output the sound in a standing sound field mode, as the fixing component is not fixed in the opening of the housing.

According to the disclosure, the switching unit is a push switch.

According to the disclosure, the opening is a thread opening, and the fixing component is a wall-mounting screw for screwing the housing on a wall-mounting bracket.

According to the disclosure, the audio output device is a television device.

According to the disclosure, an audio output system includes a wall-mounting bracket and an audio output device. The wall-mounting bracket is installed on a supporting plane, and a hole is formed on the wall-mounting bracket. The audio output device includes a housing, a speaker, a switching unit, a fixing component and a control unit. An opening is formed on the housing. The speaker is for outputting sound. The switching unit is installed inside the housing. The fixing component is fixed in the opening of the housing for pressing to trigger the switching unit so that the switching unit outputs a switching signal. The control unit is electrically connected to the switching unit and the speaker, the control unit controls the speaker to output sound in a corresponding sound field mode as the control unit receives the switching signal.

The audio output system controls the speaker to output sound in the wall-mounting sound field mode by simply fixing the fixing component on the housing to press the switching unit, in the present disclosure. When the fixing component is not fixed on the housing and does not trigger the switching unit, the speaker can output sound in the standard standing sound field mode, that is, the audio output system is installed in the standing mode. The simple-structured fixing component can achieve both functions of fixing the housing on the wall-mounting bracket and triggering the switching unit to switch the sound field mode simultaneously, so that the inconvenience in switching the sound field mode manually by a user in a conventional system is improved.

These and other objectives of the present disclosure will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of an audio output system according to an embodiment of the present disclosure.

FIG. 2 is a schematic drawing of the audio output system according to the embodiment of the present disclosure.

FIG. 3 is an exploded diagram of the audio output system according to the embodiment of the present disclosure.

FIG. 4 is a rear view of the audio output system according to the embodiment of the present disclosure.

FIG. 5 is a cross-sectional diagram of the audio output system along line I-I′ in FIG. 4 according to the embodiment of the present disclosure.

FIG. 6 is a flow chart of the audio output system outputting sound in a corresponding sound field mode according to the embodiment of the present disclosure.

FIG. 7 is a partial enlarged cross-sectional diagram of the audio output system as a fixing component is not fixed in a housing of an audio output device according to the embodiment of the present disclosure.

FIG. 8 is a partial enlarged cross-sectional diagram of the audio output system as the fixing component is fixed in the housing of the audio output device according to the embodiment of the present disclosure.

### DETAILED DESCRIPTION

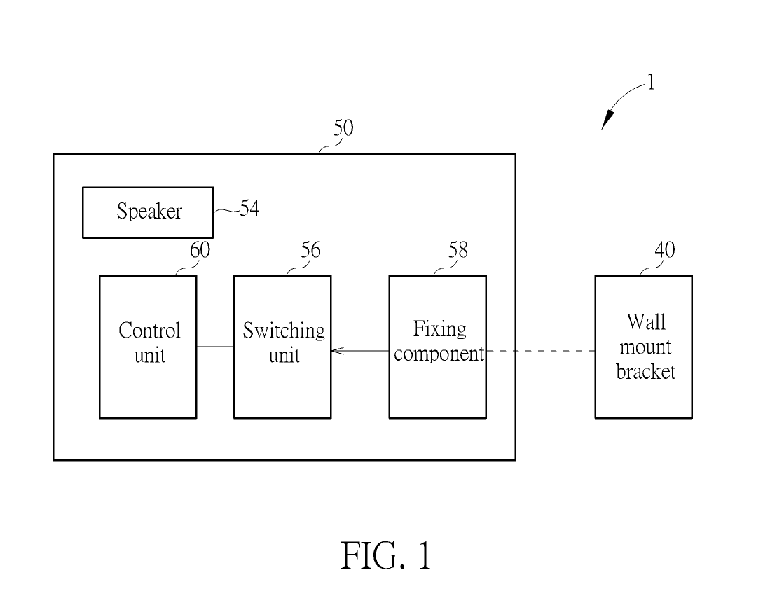

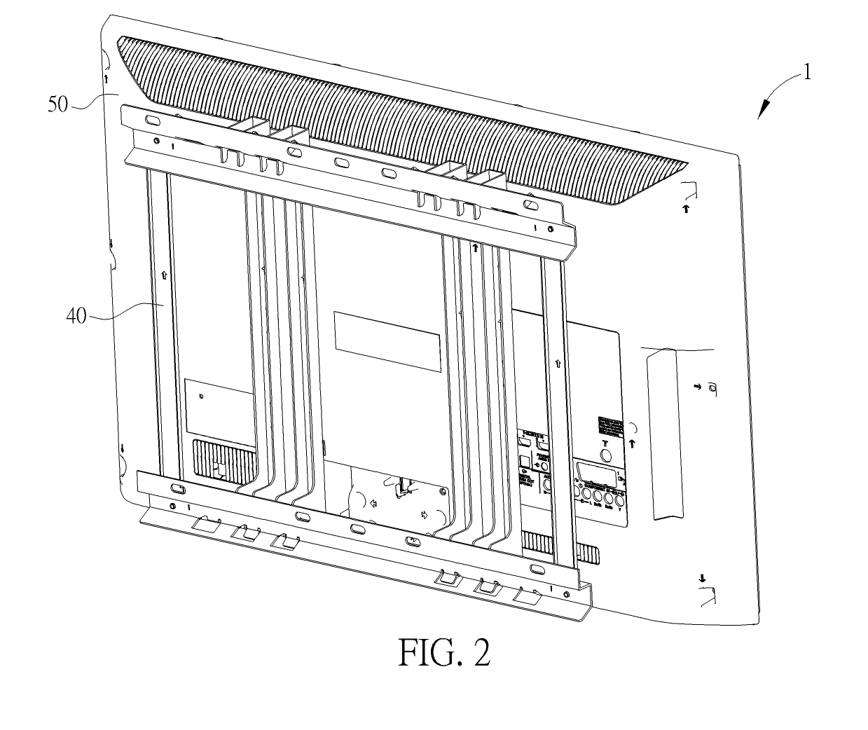

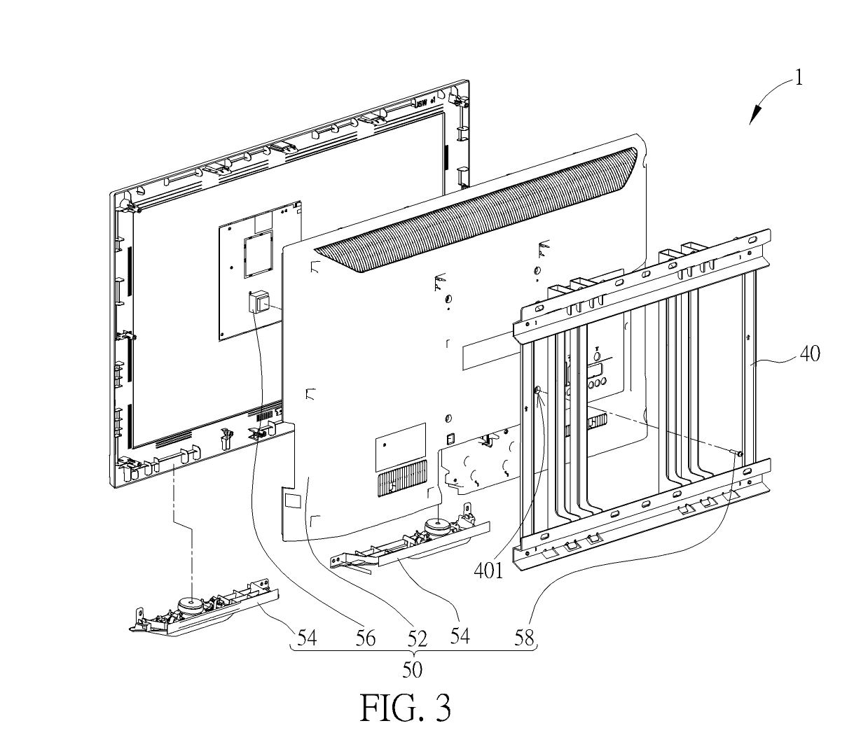

Please refer to FIG. 1 to FIG. 3. FIG. 1 is a functional block diagram of an audio output system 1 according to an embodiment of the present disclosure. FIG. 2 is a schematic drawing of the audio output system 1 according to the embodiment of the present disclosure. FIG. 3 is an exploded diagram of the audio output system 1 according to the embodiment of the present disclosure. The audio output system 1 includes a wall-mounting bracket 40 and an audio output device 50. The audio output device 50 can be a television device, such as a flat-screen TV. The wall-mounting bracket 40 is installed on a supporting plane, such as a wall, so that the audio output device 50 can be fixed on the supporting plane, and a hole 401 is formed on the wall-mounting bracket 40. The audio output device 50 includes a housing 52, a speaker 54, a switching unit 56, a fixing component 58 and a control unit 60.

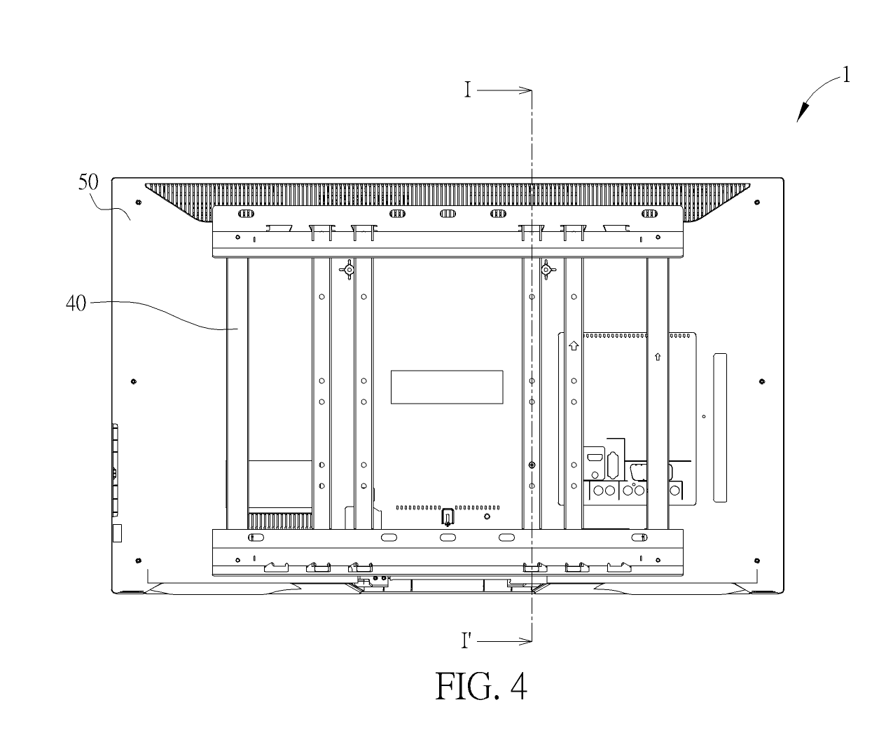

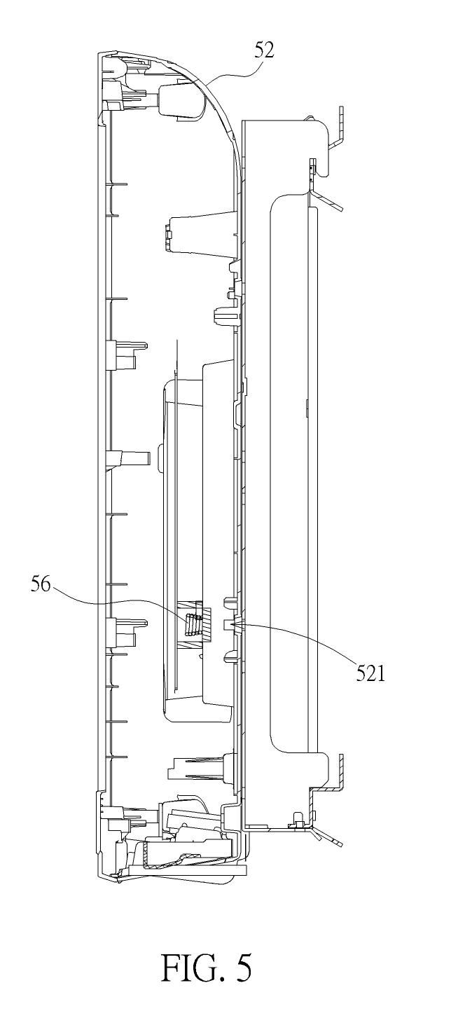

Please refer to FIG. 1 to FIG. 5. FIG. 4 is a rear view of the audio output system 1 according to the embodiment of the present disclosure. FIG. 5 is a cross-sectional diagram of the audio output system 1 along line I-I′ in FIG. 4 according to the embodiment of the present disclosure. An opening 521 is formed on the housing 52, and the switching unit 56 is installed inside the housing 52. The fixing component 58 can pass through the hole 401 of the wall-mounting bracket 40 to be fixed in the opening 521 of the housing 52, so as to fix the housing 52 on the wall-mounting bracket 40. The opening 521 of the housing 52 can be a thread opening, and the fixing component 58 can be a wall-mounting screw correspondingly for screwing the housing 52 on the wall-mounting bracket 40. The fixing component 58 is fixed in the opening 521 for pressing to trigger the switching unit 56, so that the switching unit 56 outputs a switching signal. The switching unit 56 can be a push switch. The control unit 60 is electrically connected to the switching unit 56 and the speaker 54. The control unit 60 controls the speaker 54 to output sound in a corresponding sound field mode as the control unit 60 receives the switching signal. The control unit 60 can include a general purpose input/output (GPIO) port electrically connected to the switching unit 56 for receiving the switching signal transmitted from the switching unit 56.

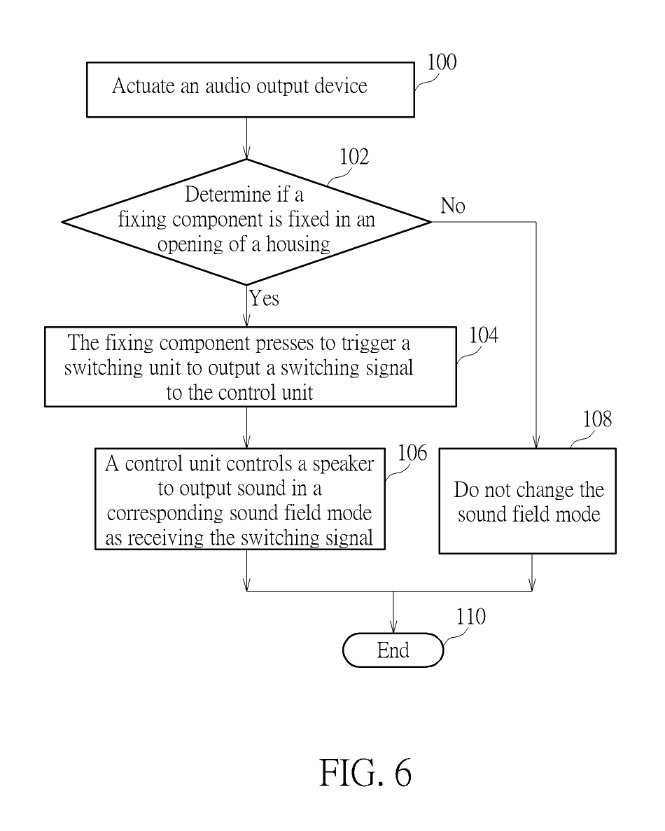

Please refer to FIG. 6. FIG. 6 is a flow chart of the audio output system 1 outputting sound in the corresponding sound field mode according to the embodiment of the present disclosure. The flow chart includes the following steps:

Step 100: Actuate the audio output device 50.

Step 102: Determine if the fixing component 58 is fixed in the opening 521 of the housing 52. If yes, go to step 104; if no go to step 108.

Step 104: The fixing component 58 presses to trigger the switching unit 56 so that the switching unit 56 outputs the switching signal to the control unit 60.

Step 106: The control unit 60 controls the speaker 54 to output sound in the corresponding sound field mode as receiving the switching signal.

Step 108: Do not change the sound field mode.

Step 110: End.

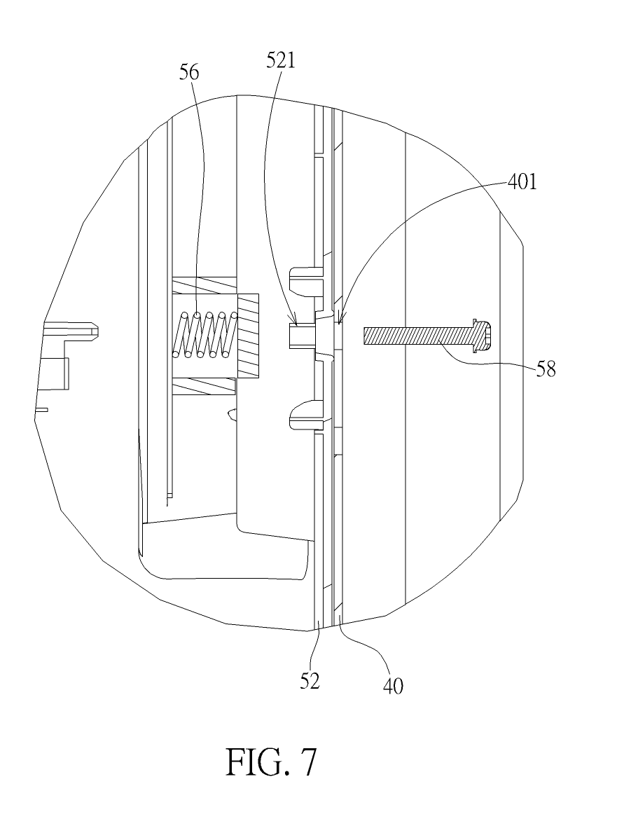

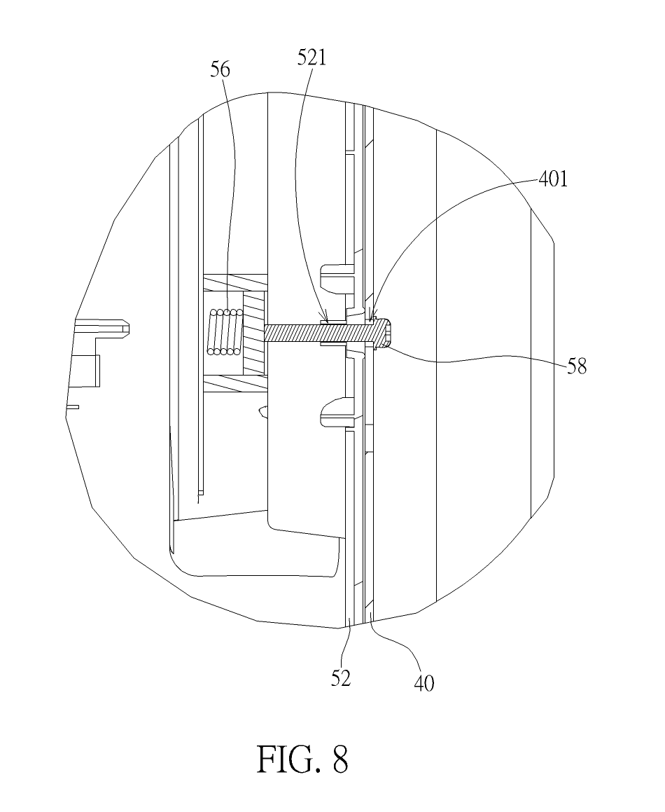

The above-mentioned steps are introduced in detail as follows. Please refer to FIG. 1, and FIG. 6 to FIG. 8. FIG. 7 is a partial enlarged cross-sectional diagram of the audio output system 1 as the fixing component 58 is not fixed in the housing 52 of the audio output device 50 according to the embodiment of the present disclosure. FIG. 8 is a partial enlarged cross-sectional diagram of the audio output system 1 as the fixing component 58 is fixed in the housing 52 of the audio output device 50 according to the embodiment of the present disclosure. Generally speaking, the audio output device 50, such as a flat-screen TV, can be optionally used in a standing mode without the wall-mounting bracket 40 or mounted on the wall by the wall-mounting bracket 40. As the audio output device 50 is not assembled with the wall-mounting bracket 40, the fixing component 58 is not fixed on the housing 52 and the wall-mounting bracket 40. As the audio output device 50 is assembled with the wall-mounting bracket 40, the fixing component 58 has to be fixed on the housing 52 of the audio output device 50 through the hole 401 of the wall-mounting bracket 40, so that the audio output device 50 is fixed with the wall-mounting bracket 40.

After the audio output device 50 is actuated, the switching unit 56 is not pressed by the fixing component 58 so that the sound field mode output by the speaker 54 is not changed, when the switching unit 56 is not pressed by the fixing component 58. When the fixing component 58 is fixed in the opening 521 of the housing 52, the fixing component 58 is designed to press to trigger the switching unit 56, so that the switching unit 56 output the switching signal to the control unit 60. The control unit 60 then controls the speaker 54 to output sounds in a corresponding sound field mode as receiving the switching signal. For example, the switching unit 56 is not grounded and output a high level switching signal to the GPIO port of the control unit 60, as the switching unit 56 is not pressed and not triggered by the fixing component 58. The control unit 60 does not amplify amplitude of a high frequency audio signal output from the speaker 54, so as to control the speaker 54 to output the sound in a standing sound field mode. The switching unit 56 is grounded to output a low level switching signal to the GPIO port, as the fixing component 58 is fixed in the opening 521 and presses to trigger the switching unit 56. The control unit 60 receives the corresponding switching signal, and the control unit 60 amplifies amplitude of a high frequency audio signal output from the speaker 54 so as to control the speaker 54 to output the sound in a wall-mounting sound field mode. That is, the frequency response of the speaker 54 is switched from the standard standing sound field mode to the wall-mounting sound field mode for high acoustic quality.

One of preferred embodiments is introduced above, and the present disclosure is not limited to this. For another example, the switching unit 56 can output a high level switching signal to the GPIO port of the control unit 60, as the fixing component 58 is fixed in the opening 521 of the housing 52 and presses to trigger the switching unit 56. And the switching unit 56 is grounded to output a low level switching signal to the GPIO port of the control unit 60, as the fixing component 58 is not fixed in the opening 521 of the housing 52. In addition, the sound field modes of the audio output device 50 are not limited to the wall-mounting sound field mode and the standing sound field mode, and it depends on the practical requirements. That is, the mechanism, which utilizes the fixing component 58 to be fixed on the opening 521 of the housing 52 for triggering the switching unit 56 so as to switch the sound field mode output by the speaker 54, is within the scope of the present disclosure.

In contrast to the prior art, the audio output system controls the speaker to output sound in the wall-mounting sound field mode by simply fixing the fixing component on the housing to press the switching unit, in the present disclosure. When the fixing component is not fixed on the housing and does not trigger the switching unit, the speaker can output sound in the standard standing sound field mode, that is, the audio output system is installed in the standing mode. The simple-structured fixing component can achieve both functions of fixing the housing on the wall-mounting bracket and triggering the switching unit to switch the sound field mode simultaneously, so that the inconvenience in switching the sound field mode manually by a user in a conventional system is improved.

Those skilled in the art will readily observe that numerous modifications and alterations of the device and method may be made while retaining the teachings of the disclosure. Accordingly, the above disclosure should be construed as limited only by the metes and bounds of the appended claims.

What is claimed is:

1. An audio output device comprising:
a housing, an opening being formed on the housing;
a speaker for outputting sound;
a switching unit installed inside the housing;
a fixing component fixed in the opening of the housing for pressing to trigger the switching unit so that the switching unit outputs a switching signal; and
a control unit electrically connected to the switching unit and the speaker, the control unit controlling the speaker to output sound in a corresponding sound field mode as the control unit receives the switching signal.

2. The audio output device of claim 1, wherein the control unit comprises a general purpose input/output (GPIO) port electrically connected to the switching unit.

3. The audio output device of claim 2, wherein the switching unit is grounded to output a low level switching signal to the general purpose input/output port, as the fixing component is fixed in the opening and presses to trigger the switching unit.

4. The audio output device of claim 1, wherein the control unit amplifies amplitude of a high frequency audio signal output from the speaker so as to control the speaker to output the sound in a wall-mounting sound field mode, as the control unit receives the switching signal.

5. The audio output device of claim 4, wherein the control unit does not amplify the amplitude of the high frequency audio signal output from the speaker so as to control the speaker to output the sound in a standing sound field mode, as the fixing component is not fixed in the opening of the housing.

6. The audio output device of claim 1, wherein the switching unit is a push switch.

7. The audio output device of claim 1, wherein the opening is a thread opening, and the fixing component is a wall-mounting screw for screwing the housing on a wall-mounting bracket.

8. The audio output device of claim 1, being a television device.

9. An audio output system comprising:
a wall-mounting bracket installed on a supporting plane, a hole being formed on the wall-mounting bracket; and
an audio output device comprising:
a housing, an opening being formed on the housing;
a speaker for outputting sound;
a switching unit installed inside the housing;
a fixing component fixed in the opening of the housing for pressing to trigger the switching unit so that the switching unit outputs a switching signal; and
a control unit electrically connected to the switching unit and the speaker, the control unit controlling the speaker to output sound in a corresponding sound field mode as the control unit receives the switching signal.

10. The audio output system of claim 9, wherein the control unit comprises a general purpose input/output (GPIO) port electrically connected to the switching unit.

11. The audio output system of claim 10, wherein the switching unit is grounded to output a low level switching signal to the general purpose input/output port, as the fixing component is fixed in the opening and presses to trigger the switching unit.

12. The audio output system of claim 11, wherein the control unit amplifies amplitude of a high frequency audio signal output from the speaker so as to control the speaker to output the sound in a wall-mounting sound field mode, as the control unit receives the switching signal.

13. The audio output system of claim 12, wherein the control unit does not amplify the amplitude of the high frequency audio signal output from the speaker so as to control the speaker to output the sound in a standing sound field mode, as the fixing component is not fixed in the opening of the housing.

14. The audio output system of claim 13, wherein the switching unit is a push switch.

15. The audio output system of claim 14, wherein the opening is a thread opening, and the fixing component is a wall-mounting screw for screwing a wall-mounting bracket on the housing.

16. The audio output system of claim 9, wherein the audio output device is a television device.

17. The audio output system of claim 9, wherein the control unit amplifies amplitude of a high frequency audio signal output from the speaker so as to control the speaker to output the sound in a wall-mounting sound field mode, as the control unit receives the switching signal.

18. The audio output system of claim 17, wherein the control unit does not amplify the amplitude of the high frequency audio signal output from the speaker so as to control the speaker to output the sound in a standing sound field mode, as the fixing component is not fixed in the opening of the housing.

19. The audio output system of claim 9, wherein the switching unit is a push switch.

20. The audio output system of claim 9, wherein the opening is a thread opening, and the fixing component is a wall-mounting screw for screwing a wall-mounting bracket on the housing.
